(19) United States
(12) Patent Application Publication
(10) Pub. No.: US 2026/0275598 A1
(43) Pub. Date: Sep. 17, 2026

(54) Composite Structure

(71) Applicant: Airbus Operations Limited, Bristol (GB)

(72) Inventor: Thomas BARNETT, Bristol (GB)

(21) Appl. No.: 19/051,513

(22) Filed: Feb. 12, 2025

(30) Foreign Application Priority Data
Feb. 15, 2024 (GB) 2402143.8

(51) Int. Cl. D04H 3/002; D04H 3/05; D04H 3/115

(52) U.S. Cl. CPC D04H 3/002; D04H 3/05; D04H 3/115; D10B 2101/12; D10B 2505/12

(57) ABSTRACT

A non-crimp fabric blanket includes fiber reinforced plies stitched together. At least one of the plies includes continuous fibers having a first fiber orientation in a first region in a plane of the ply, and a second fiber orientation in a second region in the plane of the ply. The second fiber orientation is different than the first fiber orientation.

### TECHNICAL FIELD

The disclosure herein relates to a non-crimp fabric blanket and a composite part comprising a non-crimp fabric blanket.

### BACKGROUND

Non-crimp fabrics (NCF) are typically provided as ‘blankets’ comprising two, or possibly more, fiber reinforced plies that are attached together. The fibers in each ply typically have a unidirectional fiber orientation. This results in enhanced strength of the ply along that direction. NCF blankets are widely used to manufacture composite parts because they are easy to handle in the fabrication process.

However, due to the unidirectional nature of the fiber placement, the NCF blankets suffer the problem that they can only provide improved strength in the direction of the fibers. Where the NCF blankets are formed using plies with different fiber orientations, the strength of the NCF blanket is further split between the plies due to the different fiber orientations and the stitching between the layers. This can be disadvantageous when the NCF blanket is used for form complex composite parts that require load bearing qualities in more than one plane.

### SUMMARY

A first aspect of the disclosure herein provides a non-crimp fabric blanket comprising a plurality of fiber reinforced plies stitched together, at least one of the plies comprising a plurality of continuous fibers, wherein each continuous fiber has a first fiber orientation in a first region in a plane of the ply; and a second fiber orientation in a second region in the plane of the ply, wherein the second fiber orientation is different to the first fiber orientation.

The ply may be a carbon fiber-reinforced layer with the plurality of continuous fibers embedded in a polymer matrix. The plurality of continuous fibers extend uninterrupted throughout the ply.

The NCF blanket is formed by stitching through a thickness direction of the plies. The stitching direction is in a thickness direction of the plurality of fiber reinforced plies.

The plane of each ply is flat when the plies are placed on a flat surface. The plies are flexible and can therefore be draped and shaped to form non-planar shapes.

Optionally, the plurality of continuous fibers are parallel.

Each continuous fiber does not cross the neighboring continuous fiber at any point along the ply. The plurality of continuous fibers are aligned in the same direction in the first fiber orientation. The plurality of continuous fibers are aligned in the same direction in the second fiber orientation. The plurality of continuous fibers provide mechanical strength to the ply along the continuous fibers.

Optionally, the first fiber orientation and the second fiber orientation are linear.

The plurality of continuous fibers are arranged in a substantially straight line in the first fiber orientation. The plurality of continuous fibers are arranged in a substantially straight line in the second fiber orientation.

Optionally, the plurality of continuous fibers comprise a non-linear transition region between the first fiber orientation and the second fiber orientation.

The non-linear transition region includes any shape of the continuous fibers that does not extend along a straight axis. The non-linear transition region includes any curved shape or arrangement of each continuous fiber. The non-linear transition region section connects the first fiber orientation and the second fiber orientation.

Optionally, in the non-linear transition region, each continuous fiber is a single curve with no inflection point.

Optionally, wherein in the non-linear transition region, each continuous fiber comprises a constant bend radius.

The non-linear transition region may comprise a bend. The bend radius is the radius in which the continuous fiber extends around to change direction from the first fiber orientation to the second fiber orientation. A constant bend radius means that the plurality of continuous fibers experience the same rate of change of curvature in the non-linear transition region. A constant bend radius results in each plurality of continuous fibers following a smooth curve as it transitions from the first fiber orientation to the second fiber orientation. The plurality of continuous fibers are therefore less prone to breaking or “kinking” out of a plane of the ply.

Optionally, in the non-linear transition region, each continuous fiber comprises a non-constant bend radius.

The non-constant bend radius results in the plurality of continuous fibers undergoing a different rate of change of curvature in the non-linear transition region. The plurality of continuous fibers can therefore accommodate large angle changes between the first fiber orientation and the second fiber orientation.

Optionally, the length of each continuous fiber in the transition region is smaller than the length of the continuous fiber in the first region of the ply and/or the length of the continuous fiber in the second region of the ply.

The first region and/or the second region of the ply are larger to provide larger areas to maximise the load bearing properties of the NCF blanket.

Optionally, the first fiber orientation is at a 15-degree fiber orientation relative to an edge of the blanket, and the second fiber orientation is at a 45-degree fiber orientation relative to the edge of the blanket.

Optionally, the first fiber orientation is at a 135-degree fiber orientation relative to an edge of the blanket, and the second fiber orientation is at a 15-degree fiber orientation relative to the edge of the blanket.

Optionally, each continuous fiber has a further third fiber orientation in a third region in a plane of the ply, and a second non-linear transition region between the second fiber orientation and the third fiber orientation.

Optionally, the third fiber orientation is the same as the first fiber orientation.

Optionally, at least one ply comprises fibers of carbon.

A further aspect of the disclosure herein provides a composite part comprising a plurality of non-crimp fabric blankets, wherein the composite part comprises at least one non-crimp fabric blanket as described herein.

Optionally, wherein the composite part is a non-planar part.

Non-planar means that the composite part extends in more than one plane.

Optionally, the composite part is a continuous part comprising two portions extending in different planes, wherein the first fiber orientation is aligned with the first portion, and the second fiber orientation is aligned with the second portion.

Optionally, the first portion is a flange of the composite part, and the second portion is a web of the composite part, wherein the transition region is aligned with a bend radius of the flange.

Optionally, the composite part is an aircraft part.

Optionally, the composite part is a spar.

### BRIEF DESCRIPTION OF THE DRAWINGS

Embodiments of the disclosure herein will now be described with reference to the accompanying drawings, in which:

FIG. 1 shows an exploded view of an example NCF blanket;

FIG. 2 shows a top-down view of an example fiber reinforced ply;

FIGS. 3A and 3B show example arrangements of the non-linear transition region of the continuous fibers;

FIG. 4 shows a top-down view of another example fiber reinforced ply;

FIG. 5 shows an aircraft;

FIG. 6 shows a cross-sectional view of a wingbox; and

FIG. 7 shows a spar in more detail.

### DETAILED DESCRIPTION

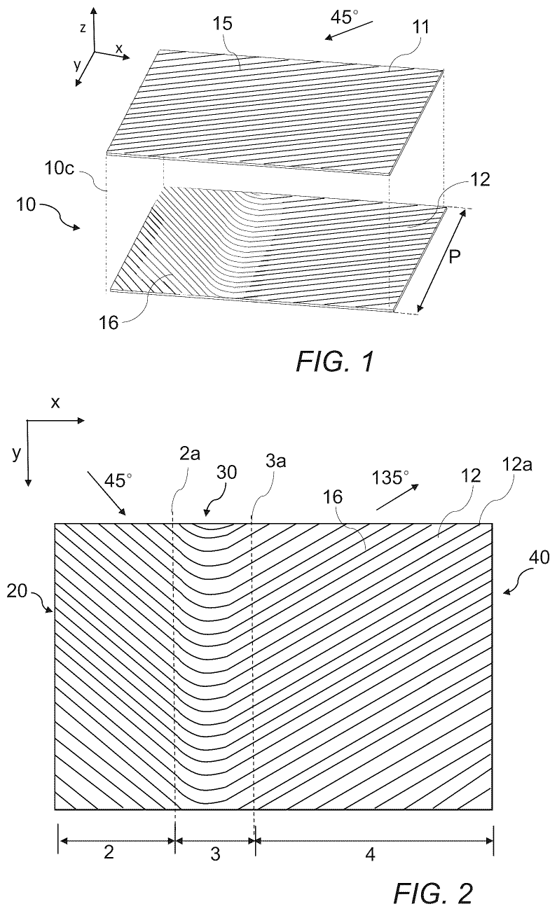

An exploded view of an example non-crimp fabric (NCF) blanket 10 is shown in FIG. 1. In this example, the NCF blanket 10 includes two fiber reinforced plies 11,12. The fiber reinforced piles 11,12 are joined together, e.g. by stitching, generally indicated by the broken lines 10c, to form the blanket 10. The fiber reinforced plies 11,12 are provided as layers that contain a plurality of continuous fibers 15,16. At least one ply 11,12 may comprise fibers 15,16 of carbon.

The fiber reinforced plies 11, 12 are generally planar and are generally provided in the orientation shown in FIG. 1. References to the vertical direction refers to dimensions or movement along the axis marked Z in FIG. 1. Reference to lateral or transverse directions refer to movement in the directions marked X (width) and Y (depth) in FIG. 1. The continuous fibers 15,16 are arranged to extend along the plies 11, 12 in the X and Z direction. The continuous fibers 15,16 therefore extend in the plane (generally indicated by P) of the plies 11, 12 and do not protrude from an upper surface of the plies 11,12 in the Z direction.

The continuous fibers 15, 16 in the fiber reinforced plies 11,12 have different fiber orientations. In this example, the ply 11 contains a plurality of continuous fibers 15 that have a unidirectional fiber orientation, i.e. the fibers 15 extend in one direction along the ply 11. In this example, the continuous fibers 15 have a 45° fiber orientation. The orientation of the fibers is determined from an edge 12a of the blanket 10. In this example, the edge 12a is determined along the length of the blanket, however, any suitable edge 12a may be used.

A top-down view of an example fiber reinforced ply 12 containing a plurality of continuous fibers 16 is show in FIG. 2. Each continuous fibers 16 has a length, L, and is arranged to extend through a first region 2, a transition region 3 and a second region 4 of the ply 12, as illustrated with example boundary lines 2a, 3a. As shown in FIG. 2, each continuous fiber 16 is spaced at a distance X from each other. The distance X is maintained between each continuous fiber 16 in the first region 2. However, the distance X may change in the transition region 3 and the second region 4 of the ply 12 depending on the direction of the continuous fibers 16. The plurality of continuous fibers 16 are parallel in the ply 12. Each continuous fiber 16 does not cross over a neighboring continuous fiber 16 at any point along the ply 12. The continuous fibers 16 are arranged to extend uninterrupted through the ply 12.

In the first region 2, each continuous fiber 16 has a first fiber orientation 20 in the plane P of the ply 12. As shown, the first fiber orientation 20 is unidirectional so that each continuous fiber 16 extends in the same direction along the first region 2 of the ply 12. The plurality of continuous fibers 16 extend in a linear direction in the first region 2. In the example shown in FIG. 2, the first fiber orientation is at a 135° fiber orientation relative to the edge of the blanket 12a.

In the second region 4, each continuous fiber 16 has a second fiber orientation 40 in the plane P of the ply 12. The second fiber orientation 40 is also unidirectional, so each continuous fiber 16 extends in the same direction along the second region 4 of the ply 12. The plurality of continuous fibers 16 extend in a linear direction in the second region 4. As shown, the second fiber orientation 40 of the plurality of fibers 16 is different from the first fiber orientation 20. In this example, the second fiber orientation is at a 15° fiber orientation relative to the edge of the blanket 12a.

The mechanical properties of the ply 12 is dependent on the orientation and alignment of the plurality of fibers 16. The ply 12 will exhibit greater strength in a direction of loading if the fiber orientation is aligned with a loading direction of the ply 12. Aligning the plurality of fibers 16 in different fiber orientations in the first and second regions 2, 4 affects the load bearing qualities of the ply 12, which in turn affects the load bearing qualities of the NCF blanket 10. By altering the first and second fiber orientations 20, 40 of the plurality of fibers 16, the NCF blanket 10 can be optimized to react to different loads depending on the application of the NCF blanket 10. This is advantageous when the NCF blanket 10 is used to create a subsequent composite part 100 (discussed in more detail below).

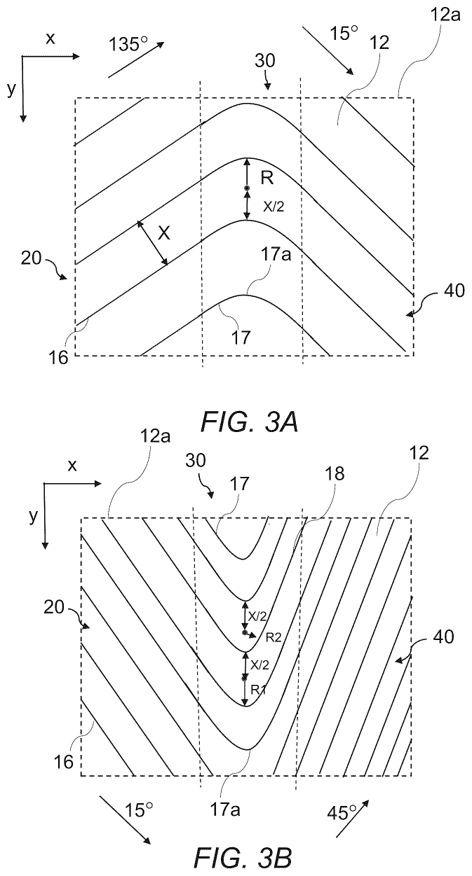

In the transition region 3, the plurality of continuous fibers 16 comprise a non-linear transition region 30. As shown in FIG. 3, the non-linear transition region 30 of the plurality of continuous fibers 16 is between the first fiber orientation 20 and the second fiber orientation 40 of the continuous fibers 16. The non-linear transition region 30 of the plurality of continuous fibers 16 therefore connects the first region 2 and the second region 4 of the ply 12. The plurality of continuous fibers 16 are arranged to change direction from the first fiber orientation 20 to the second fiber orientation 40 in the non-linear transition region 30.

The plurality of continuous fibers 16 extend in a non-linear direction in the non-linear transition region 30. The non-linear transition region 30 comprises a bend. The plurality of continuous fibers 16 are arranged to change direction from the first fiber orientation 20 to the second fiber orientation 40 in the transition region 3. As shown more clearly in FIG. 3A, in the non-linear transition region 30, the plurality of continuous fibers 16 comprises a single curve 17. Preferably, the single curve 17 has a single peak 17a in the transition region 3. The peak 17a of the continuous fibers 16 may define a bend radius R of the non-linear transition region 30. The bend radius R may be defined from half the distance X between neighboring continuous fibers 16.

As shown in FIG. 3A, the single curve 17 does not have an inflection point. Each continuous fiber 16 comprises a curve 17 that reaches a peak 17a before changing direction towards the second fiber orientation 40. In this example, the curve 17 is concave. As shown, the non-linear transition region 30 of each continuous fiber 16 is substantially identical. The curved arrangement of the non-linear region 30 allows the plurality continuous fibers 16 to change direction smoothly from the first fiber orientation 20 to the second fiber orientation 40. The continuous fibers 16 are therefore less likely to “kink” of deform out of the plane P of the ply 12. This is likely to occur when the NCF blanket 10 is formed into a composite part 100.

While the example regions 2, 3 are illustrated with example boundary lines 2a, 3a, it will be understood that these are merely illustrative. In reality, the example regions 2, 3, 4 are defined by the length of the plurality of continuous fibers 16 that extend in the first fiber orientation 20, the non-linear transition direction 30 and the second fiber orientation 40.

FIGS. 3A and 3B show different arrangements of the non-linear transition region 30 of the plurality of continuous fibers 16. In FIG. 3A, non-linear transition region 30 of the plurality of continuous fibers 16 is in the form of a single curve 17. The bend radius R defines the minimum radius through which the plurality of continuous fibers 16 turn around to change direction from the first fiber orientation 20 to the second fiber orientation 40. The peak 17a of the curve 17 is defined by the bend radius R of the non-linear transition region 30. The bend radius R in FIG. 3A is constant, i.e. the plurality of continuous fibers 16 extend around a smooth and continuous curve to change direction into the second fiber orientation 40. A constant bend radius R reduces the stress concentration experienced by the plurality of continuous fibers 16. This reduces the likelihood of the fibers 16 breaking or “kinking” out of the plane P of the ply 12.

FIG. 3B shows another example non-linear transition region 30. Similar to the arrangement shown in FIG. 3A, the non-linear transition region 30 comprises a single curve 17. In the arrangement shown in FIG. 3B, the non-linear transition region 30 follows a non-constant bend radius R1. The radius R1 of the plurality of continuous fibers 16 therefore changes along the length of the fibers 16 in the transition region 2. As shown, the radius R1 from half the distance X between neighboring continuous fibers 16 to the peak 17a of the curve 17 is larger than the radius R2 from the half the distance X between neighboring continuous fibers 16 to the curve 17 nearest the second region 40. In this arrangement, the length of the continuous fibers 16 in the transition region 2 is minimized, so the plurality of continuous fibers 16 can change direction into the second fiber orientation 40 in shorter distances of the ply 12. The continuous fibers 16 can also therefore accommodate larger fiber orientation changes from the first fiber orientation 20 to the second fiber orientation 40. The plurality of continuous fibers 16 can therefore be orientated in a large variety of directions in the second fiber orientation.

The length of each continuous fiber 16 in the non-linear transition region 30 is smaller than the length of each continuous fiber 16 that is orientated in the first fiber orientation 20 and in the second fiber orientation 40. The majority of the continuous fibers 16 in the ply are therefore arranged to provide load bearing properties of the ply 12. The size of the regions 2, 4 and/or the first and second fiber orientations 20, 40 can be adapted and optimized within the ply 12 depending on the application of the NCF blanket 10 or subsequent composite part 100 that is created using the NCF blanket 10. The plurality of continuous fibers 16 are therefore steered and placed in a manner in the ply 12 to optimize the load bearing performance of the ply 12. The configuration of the non-linear region 30 minimizes the likelihood of wrinkling, buckling and/or distortion of the ply 12 within in the NCF blanket 10.

In this example, the NCF blanket 10 includes two fiber reinforced plies 11,12. However, the NCF blanket 10 may include any number of fiber reinforced plies 11,12 stitched together. A blanket 10 comprising two fiber reinforced plies is known as a biaxial NCF, but triaxial (containing three plies) and quadriaxial blankets are available. While only one ply 12 is shown to have multiple fiber orientation in the plane of the ply 12, it will be understood that any number of plies with multiple fiber orientations may be used and stitched together to form the blanket 10. At least one ply 11, 12 in the NCF blanket 10 comprises fibers 15, 16 of carbon. A plurality of NCF blankets 10 may be arranged in a stack to achieve a generally balanced layup.

In the example shown in FIG. 2, the first fiber orientation 20 is at a 45° fiber orientation relative to the edge of the blanket 12a, and the second fiber orientation 40 is at a 135° fiber orientation relative to the edge of the blanket 12a. However, it will be understood that the first and second fiber orientations 20, 40 may be any suitable unidirectional fiber orientation from 0° to 179° relative to the edge of the blanket 12a. For example, the ply 12 arrangement shown in FIG. 3B includes a first fiber orientation 20 at a 15° fiber orientation relative to the edge of the blanket 12 a, and a second fiber orientation 40 at a 45° fiber orientation relative to the edge of the blanket 12a.

In the above example, the ply 12 includes a first region 2, a transition region 3 and a second region 4. However, the ply 12 may include any number of regions (in which the continuous fibers 16 have a unidirectional fiber orientation) connected by respective transition regions (in which the continuous fibers have a non-linear fiber orientation). The number of regions 2,4, and transition regions 3, allow the ply 12 and the NCF blanket 10 to be optimized depending on the shape and loading requirements of the final composite part 100.

A top-down view of another example ply 12 is shown in FIG. 4. The ply 12 is substantially similar to the ply 12 described in FIG. 1-3B, and so corresponding features will not be described again. As shown, the ply 12 includes a third fiber orientation 60 in a third region 6 in the plane P of the ply 12. The ply 12 also includes a second transition region 5 that connects the second region 4 with the third region 6 of the ply 12.

As shown in FIG. 4, the continuous fibers 16 are unidirectional in the third fiber orientation 60. Each continuous fiber 16 is therefore arranged to extend in the same direction along the third region 6 of the ply 12. In this example, the third fiber orientation 60 is the same as the first fiber orientation 20 of the plurality of fibers 16. In this example, the first and third fiber orientation are at a 15° fiber orientation.

The plurality of continuous fibers 16 extend in a non-linear direction in the second non-linear transition region 40. The second non-linear transition region 40 is substantially similar to the non-linear transition region 30. The second non-linear transition region 40 is arranged change the orientation of the plurality of continuous fibers 16 from the second fiber orientation 40 to the third fiber orientation 60 in the transition region 5.

In the second non-linear transition region 50, the plurality of continuous fibers 16 comprises a single curve 27. Preferably, the single curve 27 has a single peak 27a in the transition region 5. Similarly to the curve 17, the peak 27a of the continuous fibers 16 may define a bend radius R of the non-linear transition region 50. The bend radius R may be defined from half the distance X between neighboring continuous fibers 16. In the arrangements where the third fiber orientation 60 is identical to the first fiber orientation 20, the second non-linear transition region 50 may be mirrored with the first non-linear transition region 30. In other examples, the curvature 27 of the continuous fibers 16 in the second transition region 50 may be different to the curvature 17 of the first non-linear transition region 30.

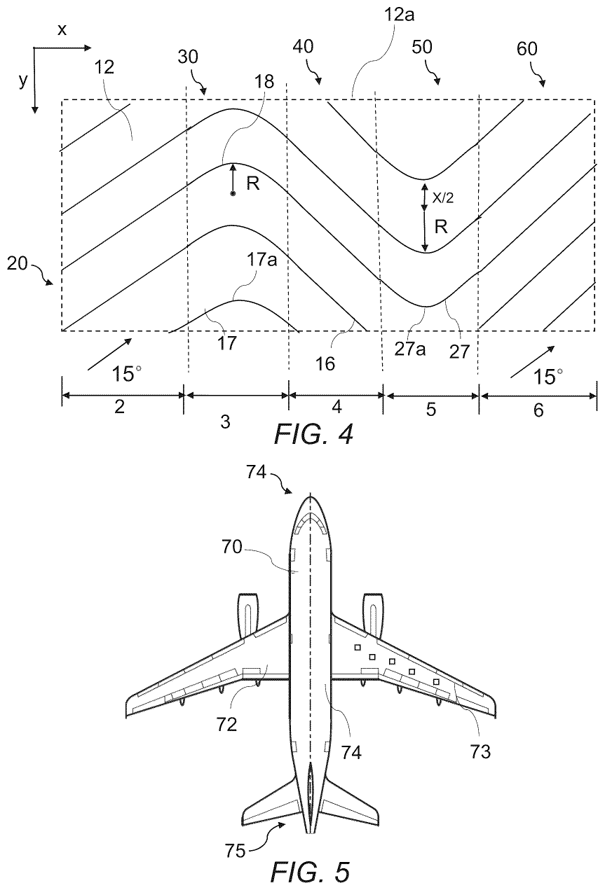

The NCF blanket 10 may be used to form a composite part 100 in a conventional manner. The plies 11, 12 may be provided as layers of dry of semi-preg carbon fiber material that can be laid up on a mould tool (not shown) to form the composite part 100. The dry or semi-preg plies within the blanket 10 may then be infused with a suitable resin and cured in a conventional manner before removing the composite part 100 from the mould tool. The resulting composite part 100 may be used in a wide variety of applications, such as naval, automotive or in an aircraft 70 as shown in FIG. 5.

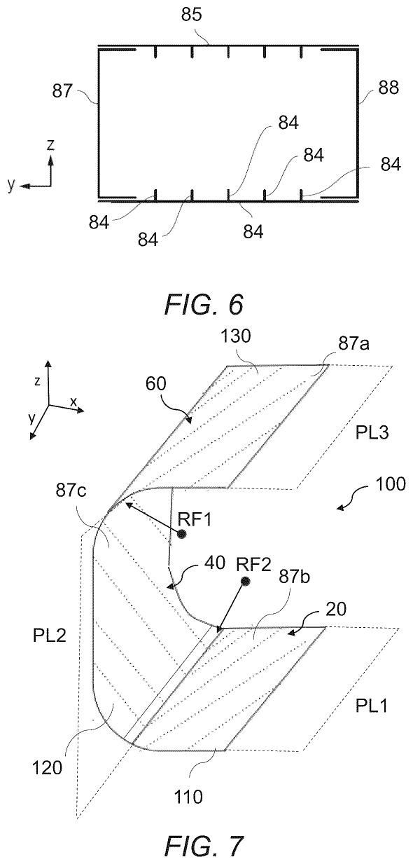

As shown, the aircraft 70 has port and starboard wings 72, 73. Each wing has a cantilevered structure with a length extending in a span-wise direction from a root to a tip, the root being joined to an aircraft fuselage 74. The fuselage 74 extends from a nose end 75 and a tail end 76. The aircraft 70 shown is a conventional transonic jet passenger transport aircraft, but it will be appreciated that this description can relate to a wide variety of aircraft including military, civilian, general aviation, jet, prop, high wing, low wing, etc. The main structural element of the wing is a wing box formed by upper and lower covers 85, 86 and front and rear spars 87, 88 shown in cross section in FIG. 6. The covers 85, 86 and spars 87, 88 are each carbon fiber reinforced polymer (CFRP) laminate components. Each cover also has an inner surface carrying ‘stringers’ or stiffeners. Each cover carries of the order of 30 to 40 stiffeners, so for the purposes of clarity only 5 are shown in FIG. 6 The stringers are labelled 84.

The NCF blanket 10 is best suited for manufacturing non-planar composite parts 100 with two or more portions 110, 120 that extend in different planes. The composite part 100 is preferably a continuous part 100. The composite part 100 is therefore preferably formed as a single, integral component. The NCF blanket 10 is preferably used to form the entirety of the part 100, and therefore is used to form the two or more portions 110, 120 of the composite part 100.

The composite part 100 may be a spar 87, as shown in FIG. 7. The spar 87 has a C-shaped cross section upper and lower spar flanges 87a, 87b each arranged to attach to the inner surface of a respective one of the covers 85, 86 and a spar web 87c extending between the spar flanges 87a, 87b.

In this example, the composite part 100 has three portions: a lower portion 110, a central portion 120 and an upper portion 130. The lower flange 87b forms the lower portion 110, the web 87c forms the central portion 120 and the upper flange 87a forms the upper portion 130. The lower portion 110 and the lower flange 87b extends in a first plane PL1, while the central portion 120 and the web 87c extends in a second plane PL2. The upper portion 130 and the upper flange 87a extends in a third plane PL3.

As shown, the first fiber orientation 20 of the NCF blanket 10 is aligned with the lower portion 110. The second fiber orientation 40 is aligned with the central portion 120, while the third fiber orientation 60 is aligned with the upper portion 130. The In this example, the first fiber orientation 20 in the lower portion 110 and the third fiber orientation 60 in the upper portion 130 is at a 15° fiber orientation. Therefore, the upper and lower flanges 87a, 87b exhibit good loading properties along in the Z direction of the spar 87 because the loading direction is substantially aligned with the orientation of the plurality of continuous fibers 16. The second fiber orientation 40 in the central portion 120 is at a 45° fiber orientation. The web 87c of the spar 87 therefore exhibits good loading properties in the shear direction of the web 87c. The fiber orientations 20, 40, 60 of the NCF blanket 10 may be adapted to be any orientation depending on the orientation and loading requirements of the composite part 100. The NCF blanket 10 can be customized so that he composite part 100 exhibits different mechanical properties along the different portions 110, 120, 130 of the part 100. The NCF blanket 10 can therefore be customized depending on the requirements of the composite part 100 to produce an optimized composite part 100.

As the composite part 100 is formed as a continuous part with portions 110, 120, 130 that extend in different planes, the continuous part 100 also includes regions of curvature where different portions 110, 120, 130 of the part change planes PL1, PL2, PL3. The curved portions of the spar 87 extend between the flanges 87a, 87b and the shear web 87c. In this example, the flanges 87a, 87c have a respective bend radius RF1, RF2. The flanges 87a, 87c bend around the bend radius RF1, RF2 to extend in the respective planes PL3, PL1. In this example, the transition region 30 of the plurality of continuous fibers 16 is aligned with the bend radius RF2 of the flange 87b, while the transition region 50 (not shown) is aligned with the bend radius RF1 of the flange 87a.

The non-linear transition regions 30, 50 of the continuous fibers 16 do not exhibit as much mechanical strength as the portions of the continuous fibers 16 that have a unidirectional arrangement (i.e. in the first fiber orientation 20, the second fiber orientation 40 or the third fiber orientation 30 where applicable), but may be more easily formed around curved surfaces of the composite part 100 without being prone to “kinking” out of plane P of the ply 12. The transitional regions 3, 5 of the NCF blanket 10 can therefore be easily formed around the curved surfaces of the composite part 100.

Although application of the NCF blanket 10 and the composite part 100 has been described in greater detail in relation to the spar 87, it will be understood that the NCF blanket 10 may be used to create any suitable composite part 100, such as the stiffeners 84 or other component of the aircraft 70. The NCF blanket 10 may equally applied to any other three-dimensional structure, such as naval or automotive applications.

Where the word ‘or’ appears this is to be construed to mean ‘and/or’ such that items referred to are not necessarily mutually exclusive and may be used in any appropriate combination.

Although the disclosure herein has been described above with reference to one or more preferred embodiments, it will be appreciated that various changes or modifications may be made without departing from the scope of the disclosure herein as defined in the appended claims.

It should be understood that modifications, substitutions, and alternatives of the invention(s) may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A non-crimp fabric blanket comprising:
a plurality of fiber reinforced plies stitched together, at least one of the plies comprising a plurality of continuous fibers, wherein each continuous fiber has a first fiber orientation in a first region in a plane of the ply, and a second fiber orientation in a second region in the plane of the ply, wherein the second fiber orientation is different than the first fiber orientation.

2. The non-crimp fabric blanket according to claim 1, wherein the plurality of continuous fibers are parallel.

3. The non-crimp fabric blanket according to claim 1, wherein the first fiber orientation and the second fiber orientation are linear.

4. The non-crimp fabric blanket according to claim 1, wherein the plurality of continuous fibers comprise a non-linear transition region between the first fiber orientation and the second fiber orientation.

5. The non-crimp fabric blanket according to claim 4, wherein in the non-linear transition region, each continuous fiber is a single curve with no inflection point.

6. The non-crimp fabric blanket according to claim 4, wherein in the non-linear transition region, each continuous fiber comprises a constant bend radius.

7. The non-crimp fabric blanket according to claim 4, wherein in the non-linear transition region, each continuous fiber comprises a non-constant bend radius.

8. The non-crimp fabric blanket according to claim 4, wherein a length of each continuous fiber in the transition region is smaller than a length of the continuous fiber in the first region of the ply and/or a length of the continuous fiber in the second region of the ply.

9. The non-crimp fabric blanket according to claim 1, wherein the first fiber orientation is at a 15-degree fiber orientation relative to an edge of the blanket, and the second fiber orientation is at a 45-degree fiber orientation relative to the edge of the blanket.

10. The non-crimp fabric blanket according to claim 1, wherein the first fiber orientation is at a 135-degree fiber orientation to an edge of the blanket, and the second fiber orientation is at a 15-degree fiber orientation to the edge of the blanket.

11. The non-crimp blanket according to claim 1, wherein each continuous fiber has a further third fiber orientation in a third region in a plane of the ply, and a second non-linear transition region between the second fiber orientation and the third fiber orientation.

12. The non-crimp blanket according to claim 11, wherein the third fiber orientation is identical to the first fiber orientation.

13. The non-crimp fabric blanket according to claim 1, wherein at least one ply comprises fibers of carbon.

14. A composite part comprising a plurality of non-crimp fabric blankets, wherein the composite part comprises at least one non-crimp fabric blanket according to claim 1.

15. The composite part according to claim 14, wherein the composite part is a non-planar part.

16. The composite part according to claim 14, wherein the composite part is a continuous part comprising two portions extending in different planes, wherein the first fiber orientation is aligned with the first portion, and the second fiber orientation is aligned with the second portion.

17. The composite part according to claim 16, wherein the first portion is a flange of the composite part, and the second portion is a web of the composite part, wherein the transition region is aligned with a bend radius of the flange.

18. The composite part according to claim 14, wherein the composite part is an aircraft part.

19. The composite part according to claim 18, wherein the composite part is a spar.
